(19) United States
(12) Patent Application Publication
(10) Pub. No.: US 2017/0034405 A1
(43) Pub. Date: Feb. 2, 2017

(54) Gun Camera

(71) Applicants: David Ryniec, Naperville, IL (US); Isaiah Ambrosini, Naperville, IL (US); Nelson Smith, Darien, IL (US)

(72) Inventors: David Ryniec, Naperville, IL (US); Isaiah Ambrosini, Naperville, IL (US); Nelson Smith, Darien, IL (US)

(21) Appl. No.: 14/815,710

(22) Filed: Jul. 31, 2015

(51) Int. Cl. H04N 5/225; F41C 33/02; F41G 11/00

(52) U.S. Cl. CPC H04N 5/2251; F41G 11/00; F41C 33/0254; F41C 33/029

(57) ABSTRACT

A combination gun camera, gun, and gun holder, whereby the recording unit is actuated upon removing the gun from a gun holder, instead of manually operated to implement immediate filming and recording of video. The recording unit is de-activated upon placing the gun in the gun holder to provide engagement between the communicating actuation devices in the holder and recording unit. The video may also be relayed to a remote destination for simultaneous viewing.

### BACKGROUND OF THE INVENTION

1. Field of the Invention

The present invention relates to gun accessories, and more specifically to a gun camera which can be attached to a common handgun.

2. Description of the Related Art

Police firearms are worn by officers performing police services. Use of guns is often under exigent circumstances, but nonetheless a review of the event is always performed. The course of the event is understood, normally only the user is able to explain the course of events during use of the instrument, unless there was a third party to act as witness or the event was recorded. Without a video recording that can be analyzed to understand the event, analysis of the use of instruments or collecting criminal evidence becomes difficult. Presently, body cameras require manual activation and sight is often blocked by the officers hands. Moreover, if an officer is on his back on the ground, his body camera is only pointing upward, and his shooting arm is at an angle. A self-initiating sensor-activated camera is needed to record from the gun itself, as a ‘first-person’ field of vision. A gun camera with wireless technology for dispatching video data is needed, for simultaneous viewing at a mobile command center.

### BRIEF SUMMARY OF THE INVENTION

Accordingly, a primary objective of the present invention is to provide a combination gun, gun holder, and a gun camera which communicate to implement automatic and immediate video recording upon removal of the gun from the holder.

In order to achieve these objectives, the gun camera of the present invention comprises a main body, a video unit, a video processing unit, a recording actuation unit. The video unit is fixed to the main body and is used to convert external video images into electronic signals. Actuation of the recording function occurs automatically upon removing the gun from the gun holder. The gun holder has a communication device for actuating the recording actuation unit and the power actuation device.

### BRIEF DESCRIPTION OF THE SEVERAL VIEWS OF THE DRAWINGS

FIG. 1 is a side view of the inventive gun camera accessory attached to a pistol.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

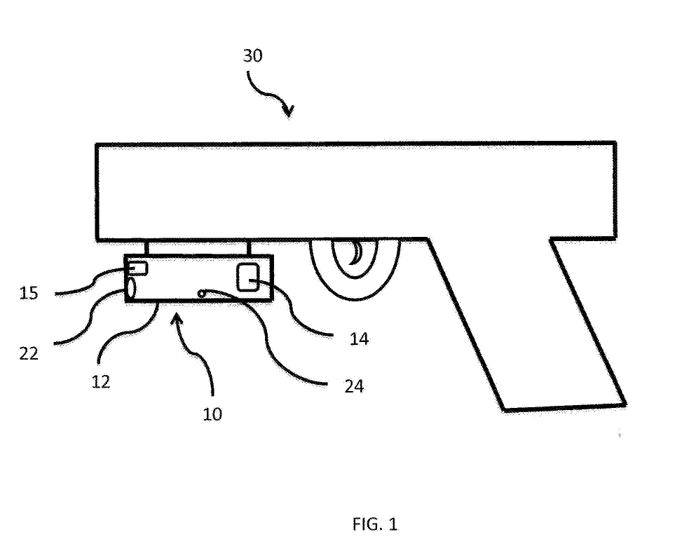

Referring to FIG. 1, a preferred embodiment of the present invention is shown. A gun camera 10 comprises a main body 12 with an interior holding space housing a video unit, a video processing unit, a recording unit, and a power supply unit (not shown). The gun camera 10 is attached to a gun 30. The gun 30 is preferably a common firearm pistol.

The main body 12 can be joined to the gun 30 by any standard means for securing gun accessories to the gun 30, such as a clamping method, screw method, and other like methods. The main body 12 can be joined to various types of long and short-barreled firearms, as well as an electric ‘stun’ gun.

The video unit has a camera lens 15 for converting external video images into electronic signals. A version of the inventive gun camera (not shown) can also have a microphone configured into the arrangement so that sound can be also be recorded along with the video.

The video processing unit is secured within the interior holding space of the main body 12. The video processing unit is a microprocessor which processes electronic signals produced by the video unit into digital video data. The recording unit is electrically connected to the video processing unit.

The power supply unit is a rechargeable battery which is replaceable and detachable. The power supply unit provides the required electric power to the video unit, the video processing unit and to the recording unit.

In addition, the gun camera may be formed with an auxiliary light unit 22. The auxiliary light unit 22 produces an illuminating light source using the electric power provided by the power supply unit. This provides lighting to facilitate the video unit in the making of video images, including for night vision video recording. The gun 30 can automatically sequence itself to the amount of light needed for optimal recording.

Using a universal serial bus (USB) electric connector enables electrical connection to an external device conforming to USB specifications. Also, the battery of the power supply unit can be recharged in this way.

The inventive gun camera 10 employs basic software that is capable of extracting and removing recorded files upon plug-in. The video data would automatically sort by date and automatically removes files. In the case of law enforcement, the data is encrypted and cannot be removed or tampered. This facilitates efficient and flawless investigation and resolution of police shooting issues. The data includes the number of times the gun was removed from the holster.

Using the aforementioned structure in conjunction with a pistol gun as an example, the gun camera 10 is inactivated when the gun 30 is holstered and not in use. In this position, the recording actuation sensors on the gun camera 10 and on the holster are in direct communication. However, removing the gun 30 from the holster breaks this communication and automatically activates video recording. The video recorder cannot be inactivated unless the gun is holstered. The video unit records video image, which usually includes sound, pointed at by the gun 30. When necessary, the auxiliary light unit 22 is activated for night vision, so immediate video recording is achieved both at night and during daylight hours.

A red green two-color LED indicator light 24 is disposed on the main body 1. A continuous red light indicates that the gun camera is in the process of video recording; a flashing red light indicates that the recording unit is full. A continuous green light indicates that the rechargeable battery is fully charged. A flashing green light indicates that the gun camera is undergoing charging through an external power supply.

While certain preferred embodiments of the present invention have been disclosed in detail, it is to be understood that various modifications may be adopted without departing from the spirit of the invention or scope of the following claims.

We claim:

1. A gun camera that can be attached to a gun, wherein the gun camera comprises:
a main body removably attached to a gun;
a video unit fixed to the main body and used to convert external video images into electronic signals;
a video processing unit positioned within the main body, wherewith electronic signals produced by the video unit are converted into digital video data;
a recording unit in communication with the video processing unit, said recording unit used to store the digital video data;
a power supply unit, which provides the electric power required by the video unit, the video processing unit,
wherein, said camera recording unit is in an activated state upon removal of said gun from a holster, and said recording unit is in a de-activated state upon replacing said gun to said holster.

2. The gun camera according to claim 1, further comprising an auxiliary light unit, which is able to produce an illuminating light source to facilitate the video unit in the formation of video images.

3. The gun camera according to claim 1, further comprising an output unit, which is used to output the digital video data.

4. The gun camera according to claim 3, wherein the output unit is a universal serial bus (USB) electric connector, which enables electrical connection to an external device.

5. A combination gun holster, gun, and a gun camera that can be attached to said gun, comprising:
(a) a recording unit used to store the digital video data inside said camera, said recording unit having an activation unit;
wherein said camera recording activation unit is in wireless communication with said holster activation unit, and said camera recording unit is in an automatically actuated state upon only removal of said gun from a holster, and said recording unit is in a de-actuated state only upon replacing said gun to said holster.
